(19) United States
(12) Patent Application Publication
(10) Pub. No.: US 2005/0066994 A1
(43) Pub. Date: Mar. 31, 2005

(54) Methods for cleaning processing chambers

(76) Inventors: Peter John Biles, Orlando, FL (US); Mario Pita, Winter Springs, FL (US); Kristian Peter Cauffman, Orlando, FL (US); William J. Cauffman, Orlando, FL (US); Thomas Craig Esry, Orlando, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/675,264

(22) Filed: Sep. 30, 2003

(51) Int. Cl. B08B 11/00

(52) U.S. Cl. 134/1.1; 134/1; 134/22.1

(57) ABSTRACT

Methods for metal etching substrates in IC manufacturing, and methods for cleaning processing chamber and substrates are disclosed herein. The disclosed methods reduce the frequency of conventional wet-cleaning processes that must be periodically conducted to clean etchant residues accumulated on the walls of the processing chamber. In an exemplified embodiment, the subject methods utilize an oxygen-containing gas during the dechuck process which reacts with, softens, burns and/or removes etchant residue present on the chamber walls and substrate.

### FIELD OF THE INVENTION

The present invention broadly relates to the field of cleaning debris produced during manufacture of semiconductors.

### BACKGROUND OF THE INVENTION

In the manufacture of integrated circuits, materials such as silicon dioxide, silicon nitride, polysilicon, metal, metal silicide, and single crytal silicon, that are deposited or otherwise formed on a substrate, are etched in predefined patterns to form gates, vias, contact holes, trenches, and/or interconnect lines. In the 5 etching process, a patterned mask composed of silicon oxide or silicon nitride (hard mask) or photoresist polymer, is formed on the substrate by conventional photolithographic methods. The exposed portions of the underlying material that lie between the features of the patterned mask are etched by capacitive or inductively coupled plasmas of etchant gas.

During the etching processes, etchant residue (often referred to as a polymer and also referred to herein as “debris”) deposits on the walls and other component surfaces inside the etching chamber. The composition of the etchant residue (residue from the etch process) depends upon the chemical composition of vaporized species of etchant gas, the material being etched, and the mask layer on the substrate. For example, when tungsten silicide, polysilicon or other silicon-containing layers are etched, silicon containing gaseous species, that form from when the above mentioned films are exposed to a plasma containing reactive gases, are vaporized or sputtered from the substrate; similarly, etching of metal layers results in vaporization of metal species. In addition, the mask layer on the substrate is also partially vaporized by the etchant gas to form gaseous hydrocarbon, fluorocarbon, chlorocarbon or oxygen-containing species. The vaporized and gaseous species condense to form etchant residue comprising polymeric byproducts composed of highly fluorinated and/or chlorinated hydrocarbons from the resist; gaseous elements such as silicon fluoride, metal chlorides, oxygen, or nitrogen; and elemental silicon or metal species depending on the composition of the substrate being etched. The polymeric byproducts deposit as thin layers of etchant residue on the walls and components in the chamber. The composition of the etchant residue typically varies considerably across the chamber surface depending upon the composition of the localized gaseous environment, the location of gas inlet and exhaust ports, and the geometry of the chamber. The compositional variant, non-homogeneous, etchant residue formed on the etching chamber surfaces has to be periodically cleaned to prevent contamination of the substrate. Typically, after processing of about 25 wafers, an in-situ plasma “dry-clean” process is performed in an empty etching chamber to clean the chamber.

It is difficult to clean-off the chemically hard residue deposited at portions of the chamber surfaces without entirely removing chemically softer residues at other portions of the chamber and eroding the underlying chamber surfaces. For example, the etchant residue formed near the chamber inlet or exhaust often has a higher concentration of etchant gas species than the residue formed near the substrate which typically contains a higher concentration of resist, hard mask, or of the material being etched.

Forming a cleaning plasma that uniformly etches away the compositionally different variants of etchant residue is difficult. Thus, after cleaning of about 1000 to 3000 wafers, the etching chamber is opened to the atmosphere and cleaned in a “wet-cleaning” process, in which an operator uses an acid or solvent to scrub off and dissolve accumulated etchant residue from the chamber walls. Typically, after the wet cleaning step, the chamber and its internal surfaces are “seasoned” by pumping down the chamber for an extended period of time, and thereafter, performing a series of runs of the etch process on dummy wafers. The internal chamber surfaces should exhibit consistent chemical surfaces, i.e., surfaces having little or no variations in the concentration, type, or functionality of surface chemical groups; otherwise, the etching processes performed in the chamber produce varying etching results from one substrate to another. In the pump-down process, the chamber is pumped down to a high vacuum environment for 2 to 3 hours to outgas moisture and other volatile species trapped in the chamber during the wet clean process. Thereafter, the etch process to be performed in the chamber, is run for 10 to 15 minutes on a set of dummy wafers, or until the chamber provides consistent and reproducible etching properties. These steps consume valuable production time.

In the competitive semiconductor industry, the increased cost per substrate that results from the downtime of the etching chamber during the dry or wet cleaning and seasoning process steps, is undesirable. It typically takes 5 to 10 minutes for each dry cleaning process step, and 8 to 10 hours to complete the wet cleaning processes. Also, the wet cleaning and seasoning process often provide inconsistent and variable etch properties. In particular, because the wet cleaning process is manually performed by an operator, it often varies from one session to another, resulting in variations in chamber surface properties and a low reproducibility of etching processes. Thus it is desirable to have an etching and cleaning process that can remove or eliminate deposition of etchant residue on the chamber surfaces, or increase the number of wafers that can be processed before wet cleaning is required.

### BRIEF SUMMARY OF THE INVENTION

This invention provides a novel metal etching process and subsequent cleaning process designed for assisting in the removal of sidewall polymers formed in the substrate and of residues formed in the plasma etching chamber. The terms etchant residue, polymer debris and debris are used interchangeably herein. The subject methods diminish wasted production time of cleaning the chamber, as the subject methods allow for more repetitions before having to shutdown the system to perform a wet clean. This invention also provides a cleaner substrate and thus enhances the sidewall polymer removal from the substrate during the post clean process.

According to a preferred embodiment, the subject invention involves subjecting a plasma chamber containing a wafer to an oxygen-containing gas, such as oxygen (O₂), ozone (O₃), NO, or NO₂, during the dechucking of the wafer. Dechucking, as that term is used in the art, refers to introduction of a gas into the etching chamber following the etching process so as to effect a release of the wafer from a support or chuck. Preferably, the introduction of the oxygen-containing gas is performed during or immediately after a metal etching on the wafer. The metal etching step may comprise subjecting a substrate comprising a metal containing layer thereon with an energized gas such as Cl₂, BCl₃, or CHF₃, or mixtures thereof. The method of introducing oxygen-containing gas following the etching steps provides improved cleaning of the substrate polymers because they can clean the polymer residue at lower temperatures (e.g. 25C vs. 240C) before the polymer is hardened by extra crosslinks produced by high temperatures in the strip chamber. Furthermore, contrary to conventional belief, the inventors have discovered that using the foregoing metal etching gas(es) followed by or in conjunction with an oxygen-containing gas does not corrode the metal on the substrate. Corrosion has been shown to occur when using oxygen-containing gases during the metal etching stage when N₂ instead of CHF₃ gas is used in the reactive gas mixture.

The invention also provides enhanced cleaning of the plasma etching chamber, especially of the plasma etching surfaces in close proximity to the substrate, i.e. plasma focus ring. By using the O₂ dechuck step proposed by this invention in combination with an in-situ non-product wafer plasma clean, the life of the plasma chamber (time between wet cleans) can be increased by 10 to 20% without any production loss time. This is accomplished by optimizing the in-situ waferless plasma clean to clean plasma chamber surfaces that are far from the substrate (top chamber dome) by manipulating the chamber pressure. In typical non-product wafer in-situ plasma cleans there are two main steps: one aimed to clean plasma chamber regions that are far away from the product wafer and another aimed to clean plasma chamber regions that are close to the product wafer. This invention already provides the means to clean the plasma chamber regions close to the product wafer such that the latter part of the non-product wafer in-situ plasma clean is not necessary.

The foregoing has outlined some of the more pertinent objectives of the present invention. These objectives should be construed to be merely illustrative of some of the more prominent features and applications of the invention. Many other beneficial results can be attained by applying the disclosed invention in a different manner of modifying the invention as will be described.

It is to be understood that the foregoing general description and the following detailed description are exemplary and explanatory only and are not to be viewed as being restrictive of the present, as claimed. These and other objects, features and advantages of the present invention will become apparent after a review of the following detailed description of the disclosed embodiments and the appended claims.

### DESCRIPTION OF THE DRAWINGS

FIG. 1 is a flow diagram showing the steps of an method embodiment of the subject invention.

### DESCRIPTION OF PREFERRED EMBODIMENTS

The present invention provides a etchant residue cleaning method, wherein the residue resulting from a metal process is softened, burnt and even removed. The processing time is thus reduced to provide a consistent yield. According to an exemplary embodiment, the subject methods are applied during or after a metal etching process that uses Cl₂, BCl₃, and CHF₃, as the etchant gas. An etchant gas mixture is introduced into a metal etching chamber containing a substrate comprising a metal containing layer to generate plasma for performing the etchant process. The metal containing layer may comprise Aluminum, or Copper, or both, and/or other metals that are layered on a substrate. The chamber is preferably equipped with an electrostatic chuck for securing the substrate during processing. During the metal etching process, or in most cases after the metal etching process, an oxygen-containing gas is introduced into the chamber and energized to form an oxygen plasma. The oxygen plasma reacts with the polymer debris thereby softening and removing the debris. In addition, the addition of the oxygen plasma serves to remove residual charge in the chamber to dechuck the substrate when the substrate is electrostatically held on an electrode (electrostatic chuck).

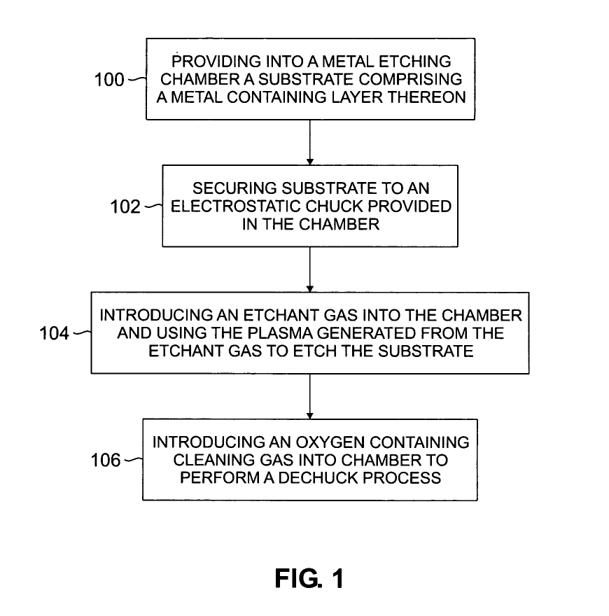

FIG. 1 is a flow diagram showing the processing steps for metal etching a substrate and dechucking the substrate according to a preferred embodiment of the present invention. The process for cleaning polymer debris of the present invention is applicable to an etching process for etching a metal layer. The preferred type of etcher used for the preferred embodiment is known as a Metal Etch DPS Tool from Applied Materials, Inc.

As shown in FIG. 1, a substrate comprising a metal containing layer is placed in a metal etching chamber 100. The metal containing layer is preferably a pure Aluminum layer or Aluminum alloy, but could comprise other metals as well. The substrate is secured to the electrostatic chuck in the chamber 102. An etchant gas is introduced into the chamber and a plasma generated from the etchant gas is used to etch the substrate 104. The reaction gas used in the conventional etching process includes a mixture of gases including Cl₂, BCl₃, and N₂. The etchant gas used in the subject methods include Cl₂, BCl₃, or CHF₃, or mixtures thereof.

An oxygen-containing gas is introduced into the chamber to perform a dechuck process 106. The oxygen-containing gas reacts with residue formed during the metal etching step thereby softening and even removing such residue. The oxygen-containing gas is used in place of Argon which is typically used as the dechuck gas. Use of the oxygen-containing gas reduces the amount and size of the fall out particles at the end of the etch because the oxygen attacks the CHF₃ polymer byproducts by breaking them up or volatizing them. This cannot be done with Argon because it is an inert gas. Any residue that is not cleaned by the oxygen-containing gas is softened and therefore more easily removed by standard cleaning processes.

Examples of etching processes and cleaning processes known in the art include, for example, those disclosed in U.S. 2003/0022513 and WO 01/08209, whose teachings are herein incorporated.

According to a preferred embodiment, the process parameters of the dechuck step 106 using a Metal Etch DPS Tool are shown in Table 1.

TABLE 1

| | |
|---|---|
| Source Power | 400-1300 Watts, preferably 900 Watts |
| Bias Power | 10-120 Watts, preferably 50 Watts |
| Pressure | 1-100 mTorr; preferably 3-10 mTorr |
| O2 Flow | 50-150 sccm; preferably 100 sccm |
| Dechuck time | 1-100 seconds; preferably 10 seconds |

It should be understood that various modifications or changes in light thereof will be suggested to persons skilled in the art and are to be included within the spirit and purview of this application and the scope of the appended claims. The teachings of all cited references are incorporated in their entirety to the extent they are not inconsistent with the teachings herein.

1. A method of cleaning a metal etch chamber during a dechuck process comprising:
placing into a chamber a substrate having a layer thereon of a metal material;
introducing a process gas comprising Cl₂, BCl₃, or CHF₃, or mixtures thereof, into the chamber;
generating a plasma in the chamber to generate from the process gas, an etch gas that etches metal from the substrate; and
performing a dechuck process by introducing into the chamber an oxygen-containing gas.

2. The process of claim 1 wherein the oxygen-containing gas reacts with polymers produced by the etching process to produce an exhaust product.

3. The process of claim 1 wherein the oxygen-containing gas is O₂, O₃, NO or NO₂, or mixtures thereof.

4. The process of claim 1 wherein the oxygen-containing gas comprises essentially O₂.

5. A method of cleaning polymer residue from an etching chamber during etching of a substrate in the chamber, wherein said substrate comprises a metal-containing layer thereon, and the polymer residue is formed on surfaces in the chamber, the method comprising the steps of:
placing the substrate in the chamber;
in a first stage, providing an etchant gas in the chamber comprising Cl₂, BCl₃, and CHF₃, or mixtures thereof; and
in a second stage, providing a dechucking gas in the chamber comprising O₂, O₃, NO or NO₂, or mixtures thereof.

6. The method of claim 5, wherein the dechucking gas consists essentially of O₂.

7. The method of claim 5, wherein said metal-containing layer comprises Aluminum.

8. A method of cleaning etchant debris in a chamber containing a substrate secured to an electrostatic chuck comprising: subsequent to or concurrent with a metal-etching process performed on said substrate, introducing a cleaning gas into said chamber, wherein said cleaning gas comprises an oxygen-containing gas.

9. The method of claim 8 wherein introducing said cleaning gas serves to remove residual charge in said chamber thereby assisting with dechucking said substrate from the electrostatic chuck.

10. The method of claim 8 wherein the chamber pressure is maintained at from about 1 mTorr to about 100 mTorr.

11. The method of claim 8 wherein the chamber pressure is maintained at from about 1 mTorr to about 15 mTorr.

12. The method of claim 8 wherein the chamber pressure is maintained at about 5 mTorr.

13. The method of claim 8 wherein said cleaning gas is in a plasma sustained at a source power from about 200 Watts to about 1300 Watts.

14. The method of claim 8 wherein said cleaning gas is in a plasma sustained at a source power of about 900 Watts.

15. The method of claim 8 wherein said cleaning gas comprises 100 sccm of O₂.

16. The process of claim 1, wherein said process gas comprises Cl₂, BCl₃, and CHF₃.
